(19) United States
(12) Patent Application Publication
(10) Pub. No.: US 2022/0405581 A1
(43) Pub. Date: Dec. 22, 2022

(54) NEURAL NETWORK OPTIMIZATION SYSTEM, NEURAL NETWORK OPTIMIZATION METHOD, AND ELECTRONIC DEVICE

(71) Applicant: Hitachi, Ltd., Tokyo (JP)

(72) Inventors: Tadanobu TOBA, Tokyo (JP); Takumi UEZONO, Tokyo (JP); Kenichi SHIMBO, Tokyo (JP); Hiroaki ITSUJI, Tokyo (JP); Nozomi KASAHARA, Tokyo (JP); Yutaka UEMATSU, Tokyo (JP)

(21) Appl. No.: 17/642,972

(22) PCT Filed: Dec. 7, 2020
(86) PCT No.: PCT/JP2020/045418

§ 371 Date: Sep. 7, 2022

(30) Foreign Application Priority Data
Dec. 16, 2019 (JP) 2019-226142

(51) Int. Cl. G06N 3/08; G06N 3/063

(52) U.S. Cl. CPC G06N 3/08; G06N 3/063

(57) ABSTRACT

A neural network that can detect abnormality of itself while suppressing redundancy of a scale is realized. A neural network optimization system includes a definition data analysis unit configured to analyze learned neural network definition data, an internode dependence degree analysis unit configured to generate dependence degree information indicating an internode dependence degree in a learned neural network defined by the learned neural network definition data, based on an analysis result of the learned neural network definition data, and a sensitive node extraction unit configured to extract a sensitive node in the learned neural network based on the dependence degree information.

### TECHNICAL FIELD

The present invention relates to a neural network optimization system, a neural network optimization method, and an electronic device. The present invention claims the benefit of Japanese Patent Application No. 2019-226142, filed on Dec. 16, 2019, the entire contents of which are incorporated herein by reference in those designated states that allow incorporation by reference of literature.

### BACKGROUND ART

In various fields, the practical realization of artificial intelligence (hereinafter, referred to as AI) has been promoted. Generally, AI is realized by implementing a neural network onto a computer of a general-purpose processor, a graphics processing unit (GPU), a field-programmable gate array (FPGA), or the like.

Regarding a neural network, for example, Patent Literature 1 describes “A neural network means at least including a first multivalued output neural network means including a learned neural network learned using learning input data and a first multivalued teaching signal, and a multivalued threshold means transmitting a multivalued output signal by multivalue-converting an output signal of an output layer unit of the neural network, and a second multivalued output neural network means including a learned neural network learned using a second multivalued teaching signal obtained by converting the first multivalued teaching signal, and the learning input data, a multivalued threshold means transmitting a multivalued output signal by multivalue-converting an output signal of an output layer unit of the neural network, and a teaching signal reverse conversion means having a reverse conversion function from the second multivalued teaching signal into the first multivalued teaching signal, and transmitting a new multivalued output signal by reversely converting the input multivalued output signal from the multivalued threshold means, which are connected in parallel to input, a comparison means transmitting a comparison result by comparing the multivalued output signals from the first and the second multivalued output neural network means, and an output selection processing means selectively transmitting either of the multivalued output signals by performing right/wrong answer determination of the multivalued output signals from the first and the second multivalued output neural network means using the comparison result from the comparison means, and transmitting right/wrong answer determination information of the selectively transmitted multivalued output signal”.

### CITATION LIST

### Patent Literature

Patent Literature 1: JP 2001-51969 A

### SUMMARY OF INVENTION

### Technical Problem

According to the neural network means described in Patent Literature 1, in a case where unknown input data other than learning input data or test input data is input, an error of the output can be detected. Nevertheless, abnormality of a neural network itself cannot be detected. In addition, the scale of the neural network means is made redundant from an original size to a double size or more.

The present invention has been devised in view of the above-described points, and aims to realize a neural network that can detect abnormality of itself while suppressing redundancy of a scale.

### Solution to Problem

This application includes a plurality of means for solving at least part of the above-described problems, and examples of these are given as follows.

For solving the above-described problems, a neural network optimization system according to an aspect of the present invention includes a definition data analysis unit configured to analyze learned neural network definition data, an internode dependence degree analysis unit configured to generate dependence degree information indicating an internode dependence degree in a learned neural network defined by the learned neural network definition data, based on an analysis result of the learned neural network definition data, and a sensitive node extraction unit configured to extract a sensitive node in the learned neural network based on the dependence degree information.

### Advantageous Effects of Invention

According to the present invention, a neural network that can detect abnormality of itself while suppressing redundancy of a scale can be realized.

Problems, configurations, and effects other than those described above will become apparent from the description of the following embodiments.

### BRIEF DESCRIPTION OF DRAWINGS

FIG. 1 is a diagram illustrating a configuration example of a neural network optimization system according to a first embodiment of the present invention.

FIG. 2 is a flowchart describing an example of neural network optimization processing.

FIG. 3 is a diagram illustrating a modified example of a neural network optimization system.

FIG. 4 is a diagram illustrating a first configuration example of an internode dependence degree analysis unit.

FIG. 5 is a flowchart describing an example of internode dependence degree analysis processing executed by the internode dependence degree analysis unit in FIG. 4.

FIG. 6 is a diagram illustrating a second configuration example of an internode dependence degree analysis unit.

FIG. 7 is a flowchart describing an example of internode dependence degree analysis processing executed by the internode dependence degree analysis unit in FIG. 6.

FIG. 8 is a diagram illustrating an example of a learned neural network.

FIG. 9 is a diagram illustrating an example of a logic circuit indicating a self-diagnosis function-equipped learned neural network.

FIG. 10 is a flowchart describing an example of diagnosis circuit addition processing.

FIG. 11 is a diagram illustrating a configuration example of an electronic device according to a second embodiment of the present invention.

FIG. 12 is a diagram illustrating a configuration example of an electronic device according to a third embodiment of the present invention.

FIG. 13 is a diagram illustrating a configuration example of an electronic device according to a fourth embodiment of the present invention.

### DESCRIPTION OF EMBODIMENTS

Hereinafter, a plurality of embodiments of the present invention will be described with reference to the drawings. Note that, throughout all of the drawings for describing the embodiments, the same members are assigned the same reference numerals in principle, and the redundant descriptions thereof will be omitted. In addition, in the following embodiments, as a matter of course, the constituent elements (also including elemental steps) are not necessarily to be considered indispensable, unless expressly stated otherwise, and unless considered obviously indispensable in principle. In addition, as a matter of course, wordings “consists of A”, “composed of A”, “having A”, and “including A” do not exclude elements other than this unless expressly stated that only the element is included. Similarly, in the following embodiments, in the case of referring to the shapes, positional relationship, and the like of the constituent elements, the shapes and the like are considered to include equivalents substantially approximate or similar to the shapes and the like, unless expressly stated otherwise, and unless obviously excluded in principle.

<Configuration Example of Neural Network Optimization System 10>

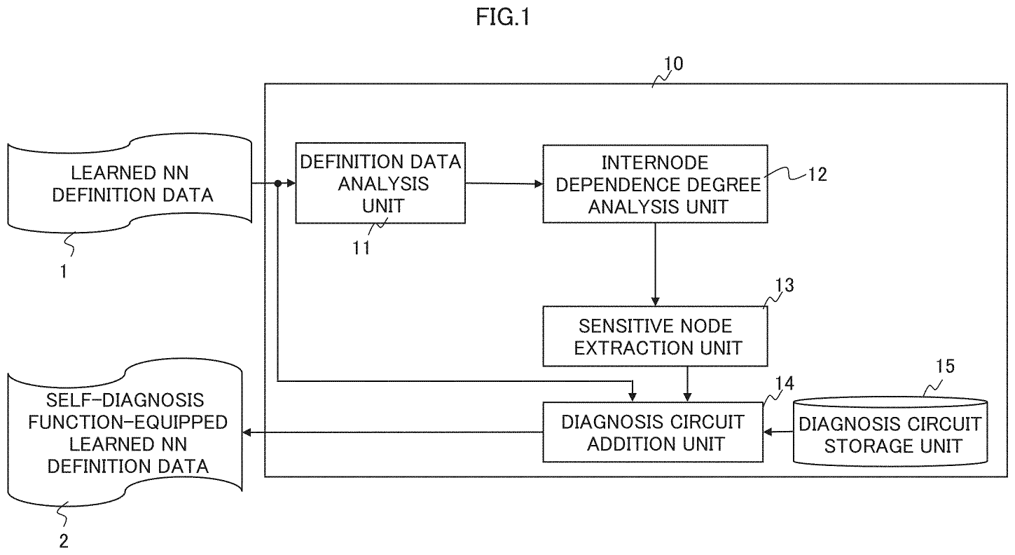

FIG. 1 illustrates a configuration example of a neural network optimization system 10 according to the first embodiment of the present invention. Hereinafter, the neural network optimization system 10 will be abbreviated as an NN optimization system 10. Similarly, a neural network will be abbreviated as an NN.

The NN optimization system 10 optimizes input learned NN definition data 1, and outputs resultant self-diagnosis function-equipped learned NN definition data 2. The NN optimization system 10 is realized by a general computer such as a personal computer (PC) including a central processing unit (CPU), a memory, a storage, an input device, an output device, a communication module, and the like, or a tool (for example, dedicated large scale integration (LSI), etc.) mounted on an electronic device.

The learned NN definition data 1 is, for example, data (for example, logic information described in a logic circuit description language, a program describing operations of a graphical processing unit (GPU) or a general-purpose processor, or the like) defining a configuration of a learned NN for executing AI processing. Hereinafter, an NN corresponding to the learned NN definition data 1 will be referred to as a learned NN 1′.

The self-diagnosis function-equipped learned NN definition data 2 is data defining a configuration in which a diagnosis circuit for detecting abnormality is added to a sensitive node (details will be described later) in the learned NN 1′. Hereinafter, an NN corresponding to the self-diagnosis function-equipped learned NN definition data 2 will be referred to as a self-diagnosis function-equipped learned NN 2′.

The NN optimization system 10 includes a definition data analysis unit 11, an internode dependence degree analysis unit 12, a sensitive node extraction unit 13, a diagnosis circuit addition unit 14, and a diagnosis circuit storage unit 15. The definition data analysis unit 11, the internode dependence degree analysis unit 12, the sensitive node extraction unit 13, the diagnosis circuit addition unit 14, and the diagnosis circuit storage unit 15 are implemented by predetermined programs being executed by a CPU of a computer constituting the NN optimization system 10.

The definition data analysis unit 11 analyzes the input learned NN definition data 1, extracts a connection relationship between nodes included in the learned NN 1′, and parameter information such as a weight coefficient and a bias value in each node, and outputs the extracted information to the internode dependence degree analysis unit 12 as NN analysis information.

Based on the learned NN definition data 1 and the NN analysis information being an analysis result thereof, the internode dependence degree analysis unit 12 generates dependence degree information indicating an internode dependence degree in the learned NN 1′, and a propagation range of data bit inversion in an abnormal state, and outputs the dependence degree information to the sensitive node extraction unit 13. Note that the dependence degree information may be generated without using the learned NN definition data 1.

The sensitive node extraction unit 13 extracts a sensitive node in the learned NN 1′ based on the dependence degree information, and outputs sensitive node data information indicating a position address thereof, to the diagnosis circuit addition unit 14. Here, the sensitive node refers to a node with high sensitivity, such as a node in which propagation of generated abnormality arrives, or a node affecting a number of nodes.

By adding a diagnosis circuit acquired from the diagnosis circuit storage unit 15, to the sensitive node in the learned NN 1′ based on the sensitive node information, the diagnosis circuit addition unit 14 generates and outputs the self-diagnosis function-equipped learned NN definition data 2.

The diagnosis circuit added to a sensitive node can detect abnormality of a corresponding node, and hold and output a time at which abnormality is detected, and abnormal node identification information (for example, node position address, parameter storage address, etc.) for identifying a node from which abnormality is detected. A node at which abnormality has occurred can be thereby conveyed to a high-order system. With this configuration, it becomes possible for the high-order system to collect an abnormal state of the learned NN 1′, and a maintenance service such as determination of severity, a repair instruction, and repair schedule planning can be implemented using the information.

The diagnosis circuit storage unit 15 stores (programs of) the diagnosis circuit to be added to each node in the learned NN 1′. The diagnosis circuit storage unit 15 corresponds to a storage of the computer constituting the NN optimization system 10.

<NN Optimization Processing Executed by NN Optimization System 10>

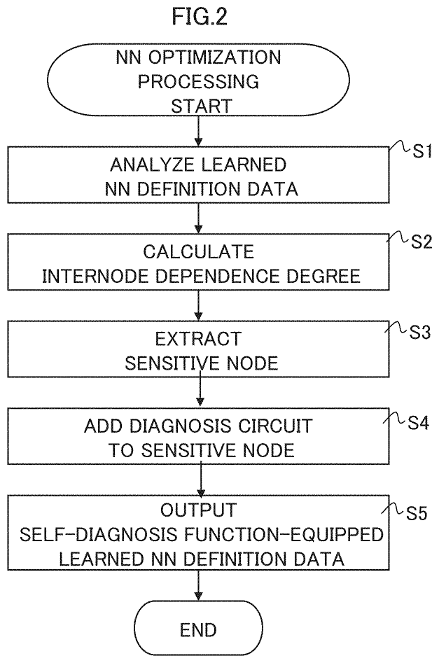

Next, FIG. 2 is a flowchart describing an example of NN optimization processing executed by the NN optimization system 10.

The NN optimization processing is started in accordance with the learned NN definition data 1 being input to the NN optimization system 10, and a predetermined start instruction being performed from a user, for example.

First of all, the definition data analysis unit 11 analyzes the input learned NN definition data 1, and outputs NN analysis information indicating an analysis result, to the internode dependence degree analysis unit 12 (Step S1).

Next, the internode dependence degree analysis unit 12 generates dependence degree information based on the NN analysis information, and outputs the dependence degree information to the sensitive node extraction unit 13 (Step S2).

Next, the sensitive node extraction unit 13 generates sensitive node information based on the dependence degree information, and outputs the sensitive node information to the diagnosis circuit addition unit 14 (Step S3).

Next, the diagnosis circuit addition unit 14 adds a diagnosis circuit to the sensitive node in the learned NN 1′ based on the sensitive node information (Step S4), and outputs the resultant data as the self-diagnosis function-equipped learned NN definition data 2 (Step S5).

According to the above-described NN optimization processing, because a diagnosis circuit is added only to a sensitive node among nodes included in the learned NN 1′, as compared with a case where diagnosis circuits are added to all nodes included in the learned NN 1′, the redundancy of the scale of the self-diagnosis function-equipped learned NN 2′ can be suppressed. As compared with an NN in which diagnosis circuits are added to all nodes, the self-diagnosis function-equipped learned NN 2′ can save various costs such as a calculation amount, power consumption, and component weight.

<Modified Example of NN Optimization System 10>

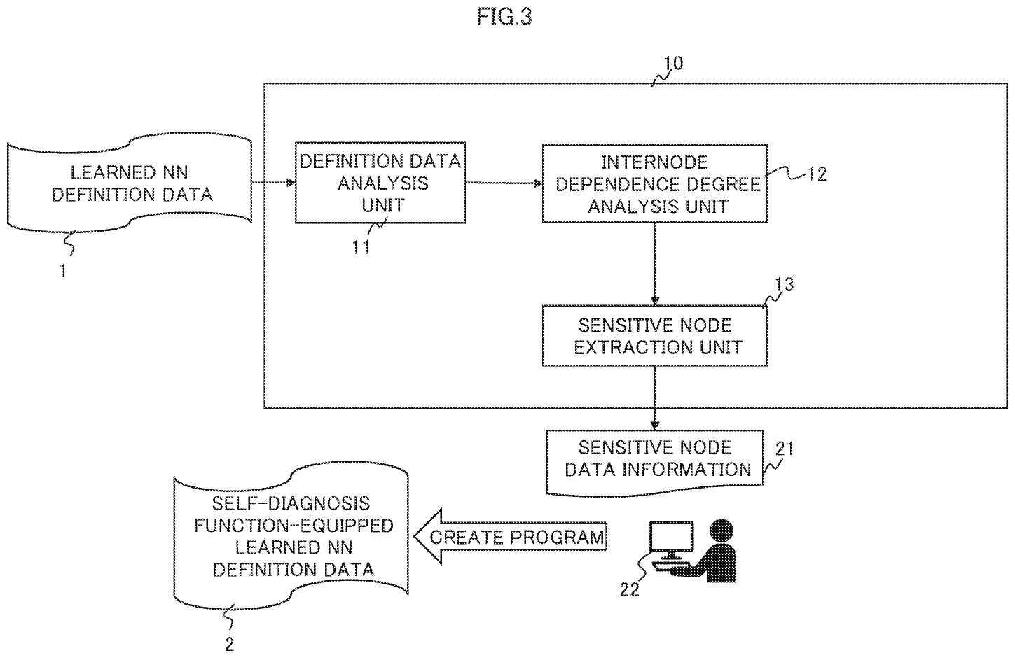

Next, FIG. 3 illustrates a modified example of the NN optimization system 10.

The modified example is an example in which the diagnosis circuit addition unit 14 and the diagnosis circuit storage unit 15 are omitted from the configuration example in FIG. 1. Note that constituent elements common to the modified example and the configuration example in FIG. 1 are assigned the same reference numerals, and the description thereof will be omitted. The same applies to the following drawings.

The sensitive node extraction unit 13 in the modified example outputs sensitive node data information 21 indicating a position address of a sensitive node in the learned NN 1′, to an external device 22 such as a PC.

In the external device 22, the self-diagnosis function-equipped learned NN definition data 2 can be generated by adding a diagnosis circuit to a sensitive node of the learned NN 1′ based on the sensitive node data information 21, manually by an operator or the like.

<First Configuration Example of Internode Dependence Degree Analysis Unit 12>

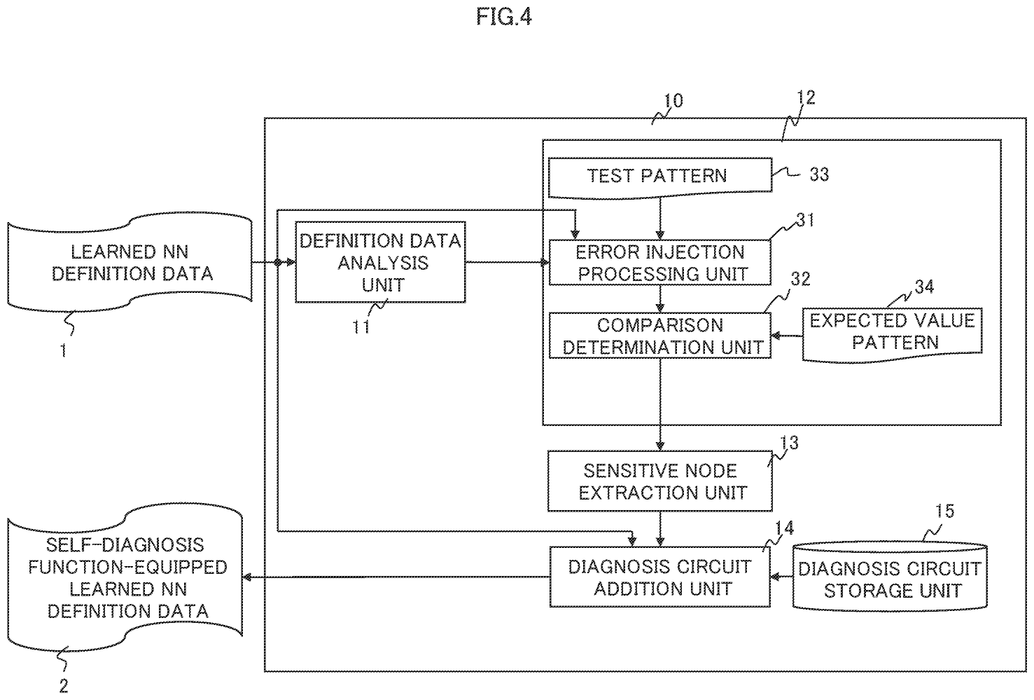

Next, FIG. 4 illustrates a first configuration example of the internode dependence degree analysis unit 12 in the NN optimization system 10.

A first configuration example of the internode dependence degree analysis unit 12 includes an error injection processing unit 31 and a comparison determination unit 32.

The learned NN definition data 1, NN analysis information being an analysis result thereof, and a test pattern 33 are input to the error injection processing unit 31. As the test pattern 33, for example, data (image data, etc.) used in the learning of the learned NN 1′ may be used, or data different from data used in the learning may be used.

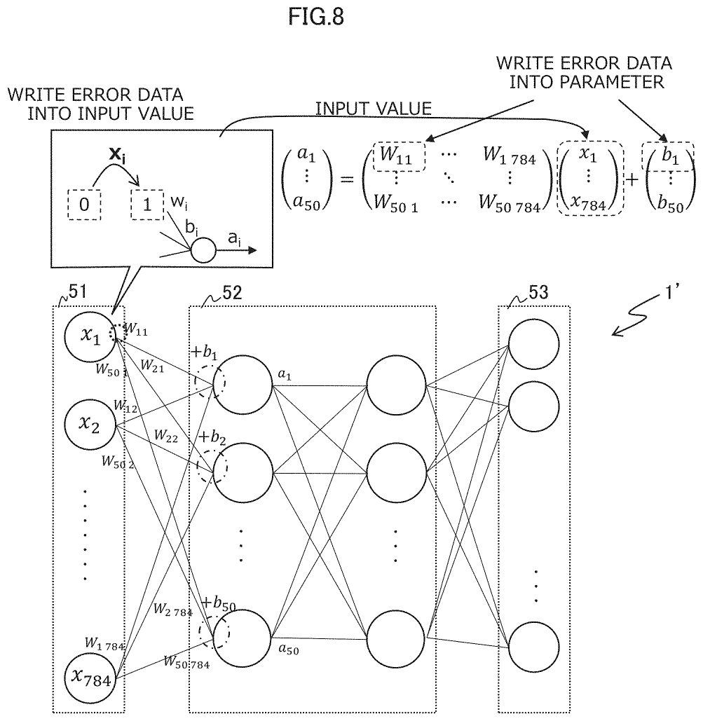

By inputting the test pattern 33 to the learned NN 1′ defined by the learned NN definition data 1, the error injection processing unit 31 acquires a result of AI processing such as recognition and determination, and outputs the result to the comparison determination unit 32. At this time, the error injection processing unit 31 writes error data into data exchanged between nodes of the learned NN 1′, and parameters such as a weight coefficient and a bias value, based on NN analysis information, and causes the learned NN 1′ to execute AI processing. Note that the writing of error data that is performed by the error injection processing unit 31 will be described later with reference to FIG. 8.

The output of the error injection processing unit 31 and an expected value pattern 34 are input to the comparison determination unit 32. The expected value pattern 34 is an output obtained by inputting the test pattern 33 to the learned NN 1′ into which error data is not written. The comparison determination unit 32 compares the output of the error injection processing unit 31 and the expected value pattern 34, and based on the comparison result, generates dependence degree information indicating an internode dependence degree in the learned NN 1′, and a propagation range of data bit inversion in an abnormal state, and outputs the dependence degree information to the sensitive node extraction unit 13.

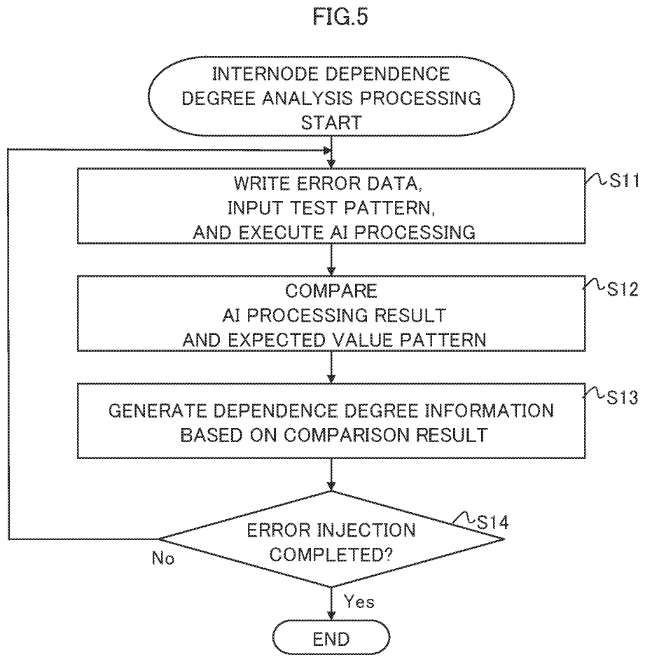

Next, FIG. 5 is a flowchart describing an example of internode dependence degree analysis processing executed by the first configuration example of the internode dependence degree analysis unit 12.

First of all, based on NN analysis information, the error injection processing unit 31 sequentially writes error data into parameters such as a weight coefficient and a bias value in nodes of the learned NN 1′, and outputs from nodes, inputs the test pattern 33 to the learned NN 1′, and causes the learned NN 1′ to execute AI processing. (Step S11). Note that, in a case where constituent elements of the learned NN 1′ includes a primary storage variable, error data may be written into the temporary storage variable. In addition, in the case of the learned NN 1′ in which the extent of the impact of error is clear, error data needs not be written into all of the above-described parameters such as weight coefficients and bias values, and outputs from nodes in some cases.

Next, the comparison determination unit 32 compares the output of the error injection processing unit 31 and the expected value pattern 34 (Step S12). Next, based on the comparison result, the comparison determination unit 32 generates dependence degree information indicating an internode dependence degree in the learned NN 1′, and a propagation range of data bit inversion in an abnormal state, and outputs the dependence degree information to the sensitive node extraction unit 13 (Step S13). Next, the error injection processing unit 31 determines whether or not writing of error data (error injection) into all nodes serving as by error data writing targets has been completed (Step S14), and in a case where it is determined that error injection has not been completed (No in Step S14), the processing returns to Step S11, and subsequent steps are repeated. After that, in a case where the error injection processing unit 31 determines that error injection has been completed (Yes in Step S14), the internode dependence degree analysis processing is ended.

According to the internode dependence degree analysis processing executed by the first configuration example of the internode dependence degree analysis unit 12, because data used in learning is used as the test pattern 33, highly-accurate dependence degree information can be generated.

<Second Configuration Example of Internode Dependence Degree Analysis Unit 12>

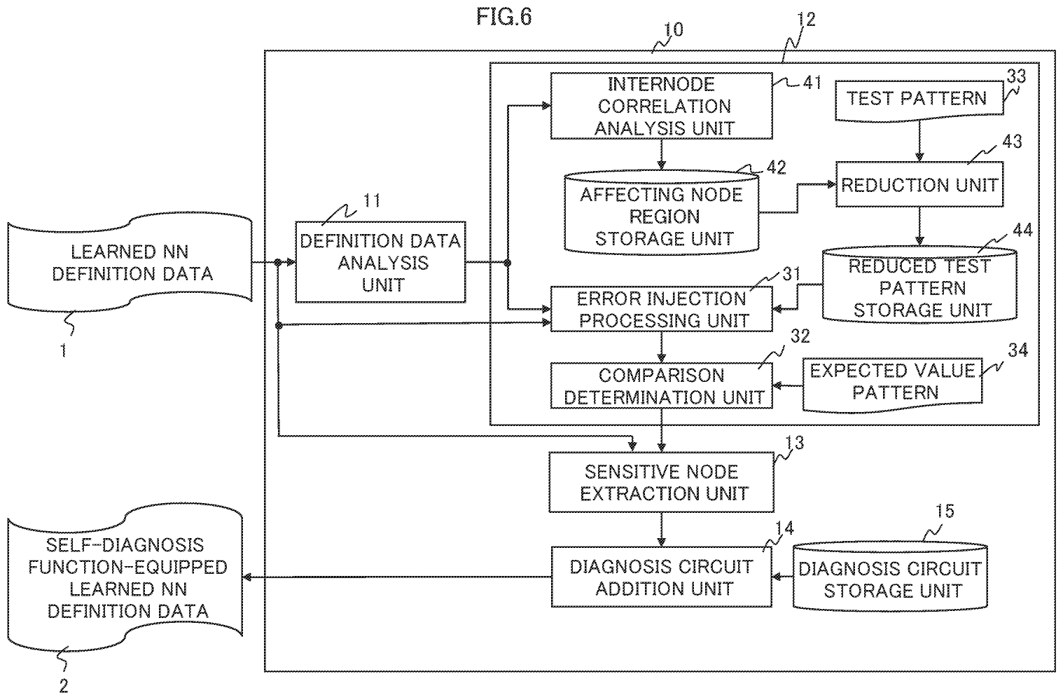

Next, FIG. 6 illustrates a second configuration example of the internode dependence degree analysis unit 12 in the NN optimization system 10.

The second configuration example of the internode dependence degree analysis unit 12 has a configuration in which an internode correlation analysis unit 41, an affecting node region storage unit 42, a reduction unit 43, and a reduced test pattern storage unit 44 are added to the first configuration example (FIG. 4).

By analyzing NN analysis information output by the definition data analysis unit 11, the internode correlation analysis unit 41 identifies a node region with a small bonding degree in the learned NN 1′, and stores information indicating the node region, into the affecting node region storage unit 42. Specifically, for example, by detecting a node with a weight coefficient larger than a predetermined threshold, that is to say, detecting a node of which output easily ignites, and excluding the node of which output easily ignites, from the learned NN 1′, a node region with a small bonding degree is identified. Note that, in place of the information indicating a node region with a small bonding degree, information indicating a node region of which output easily ignites may be stored into the affecting node region storage unit 42.

Based on the information indicating a node region with a small bonding degree that is stored in the affecting node region storage unit 42, the reduction unit 43 generates a reduced test pattern obtained by omitting data input to the node region with a small bonding degree, among all nodes of the learned NN 1′, from the test pattern 33, and stores the reduced test pattern into the reduced test pattern storage unit 44.

By inputting the reduced test pattern to the learned NN 1′ into which an error is written, the error injection processing unit 31 in the second configuration example acquires a result of AI processing such as recognition and determination, and outputs the result to the comparison determination unit 32.

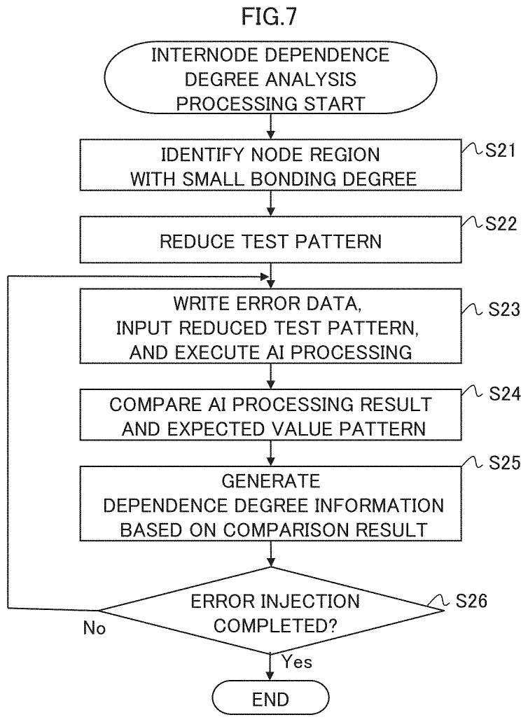

Next, FIG. 7 is a flowchart describing an example of internode dependence degree analysis processing executed by the second configuration example of the internode dependence degree analysis unit 12.

First of all, by analyzing NN analysis information output by the definition data analysis unit 11, the internode correlation analysis unit 41 identifies a node region in the learned NN 1′ that has a small bonding degree, and stores information indicating the node region, into the affecting node region storage unit 42 (Step S21).

Next, based on the information indicating a node region with a small bonding degree that is stored in the affecting node region storage unit 42, the reduction unit 43 generates a reduced test pattern obtained by omitting data input to the node region with a small bonding degree, among all nodes of the learned NN 1′, from the test pattern 33, and stores the reduced test pattern into the reduced test pattern storage unit 44 (Step S22).

Next, based on NN analysis information, the error injection processing unit 31 sequentially writes error data into parameters such as a weight coefficient and a bias value in nodes of the learned NN 1′, and outputs from nodes, inputs the reduced pattern to the learned NN 1′, and causes the learned NN 1′ to execute AI processing. (Step S23). Note that, in a case where constituent elements of the learned NN 1′ includes a primary storage variable, error data may be written into the primary storage variable. In addition, in the case of the learned NN 1′ in which the extent of the impact of error is clear, error data needs not be written into all of the above-described parameters such as weight coefficients and bias values, and outputs from nodes in some cases.

Next, the comparison determination unit 32 compares the output of the error injection processing unit 31 and the expected value pattern 34 (Step S24). Next, based on the comparison result, the comparison determination unit 32 generates dependence degree information indicating an internode dependence degree in the learned NN 1′, and a propagation range of data bit inversion in an abnormal state, and outputs the dependence degree information to the sensitive node extraction unit 13 (Step S25). Next, the error injection processing unit 31 determines whether or not writing of error data (error injection) into all nodes serving as by error data writing targets has been completed (Step S26), and in a case where it is determined that error injection has not been completed (No in Step S26), the processing returns to Step S23, and subsequent steps are repeated. After that, in a case where the error injection processing unit 31 determines that error injection has been completed (Yes in Step S26), the internode dependence degree analysis processing is ended.

According to the internode dependence degree analysis processing executed by the second configuration example of the internode dependence degree analysis unit 12, in addition to an effect similar to that of the internode dependence degree analysis processing executed by the first configuration example, being obtained, by the test pattern 33 being reduced, a time taken by the learned NN 1′ for AI processing can be shortened as compared with the first configuration example. Accordingly, it becomes possible to generate dependence degree information more quickly.

<Example of Learned NN 1′>

Next, FIG. 8 illustrates an example of the learned NN 1′. The learned NN 1′ includes an input layer 51, a hidden layer 52, and an output layer 53.

In the case of this diagram, in the input layer 51, an input value xᵢ to be input to each node is multiplied by a weight coefficient Wᵢⱼ, for example, and a bias value bi is further added to the input value xᵢ, and a calculation result aᵢⱼ is output to the hidden layer 52. In the hidden layer 52, the calculation result aᵢⱼ output by the input layer 51 is used as an input value xi, and predetermined calculation is performed similarly to the nodes of the input layer 51, and a final calculation result is output to the output layer 53.

The error injection processing unit 31 writes error data into a weight coefficient Wᵢⱼ, a bias value bi, and a calculation result aᵢⱼ in nodes of each layer. The calculation result aᵢⱼ becomes an input value xᵢ in nodes of a subsequent stage.

<Example of Logic Circuit of Self-Diagnosis Function-Equipped Learned NN 2′>

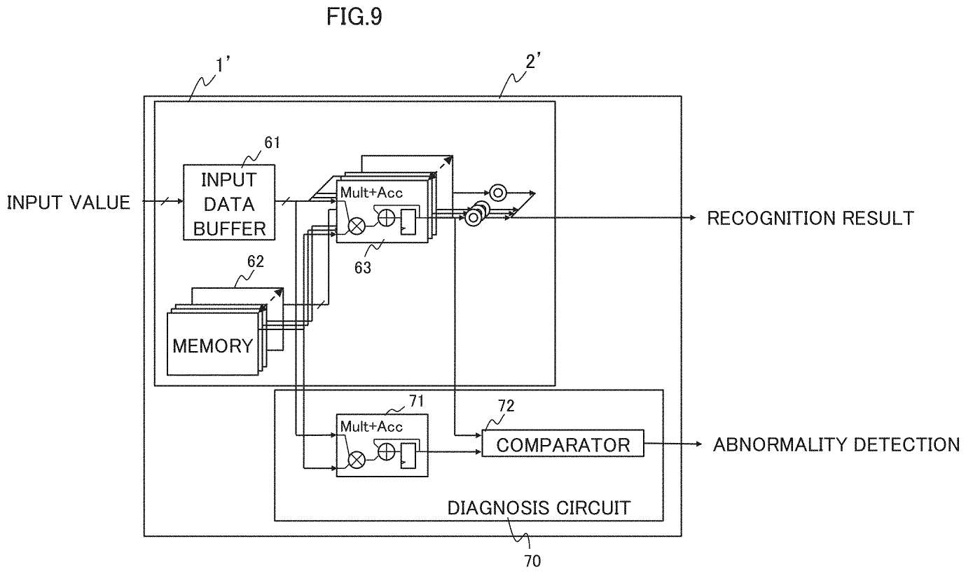

Next, FIG. 9 illustrates an example of a logic circuit of the self-diagnosis function-equipped learned NN 2′.

The self-diagnosis function-equipped learned NN 2′ is obtained by adding a diagnosis circuit 70 to a sensitive node of the learned NN 1′.

The learned NN 1′ includes a plurality of input data buffers 61 temporarily holding input data, a plurality of memories 62 holding parameters (weight coefficient Wᵢⱼ, bias value bᵢ) in each node, and a plurality of calculators 63. In the case of this diagram, the calculators 63 are product sum operational circuits that multiply input data acquired from the input data buffers 61, by the weight coefficient Wᵢⱼ held in the memories 62, and add the bias value bᵢ.

The diagnosis circuit 70 includes a calculator 71 and a comparator 72. The calculator 71 is the same product sum operational circuit as the calculators 63 in the sensitive node of the learned NN 1′, and is arranged in parallel to the calculators 63. The comparator 72 compares the output of the calculators 63 in the sensitive node of the learned NN 1′, and the output of the calculator 71, and in a case where both values disaccord with each other, determines abnormality, and outputs abnormality detection, an abnormality detection time, and abnormality-detected node identification information (for example, node position address, parameter storage address, etc.) to a high-order system.

<Diagnosis Circuit Addition Processing of Adding Diagnosis Circuit to Learned NN 1′ to Be Implemented onto GPU>

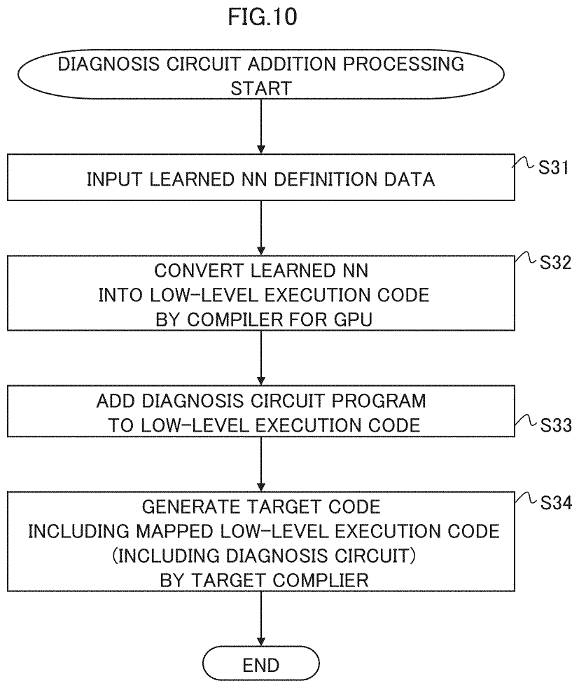

Next, FIG. 10 is a flowchart describing an example of diagnosis circuit addition processing of adding a diagnosis circuit to the learned NN 1′ to be implemented onto a GPU.

First of all, the learned NN definition data 1 is input to a compiler for a GPU (Step S31). Next, the compiler for a GPU converts the learned NN definition data 1 into a low-level executable code independent of a hardware structure of a GPU (Step S32). Here, an independent executable code refers to an executable code including described constituent elements such as a processor, a register, and a calculator in the GPU, but not being mapped with hardware components unique to a GPU onto which the learned NN definition data 1 is to be implemented.

Next, for example, based on the sensitive node data information 21 output from the modified example of the NN optimization system 10 illustrated in FIG. 3, by adding a diagnosis processing program to the low-level executable code manually by an operator or the like, the low-level executable code (including diagnosis circuit) is generated (Step S33).

Next, a target code dedicated for an implementation device in which the low-level executable code (including diagnosis circuit) is mapped with hardware components of a GPU onto which the learned NN definition data 1 is to be implemented is generated by a target complier (Step S34). In the above-described manner, the diagnosis circuit addition processing is ended.

<Configuration Example of Electronic Device 80 According to Second Embodiment of Present Invention>

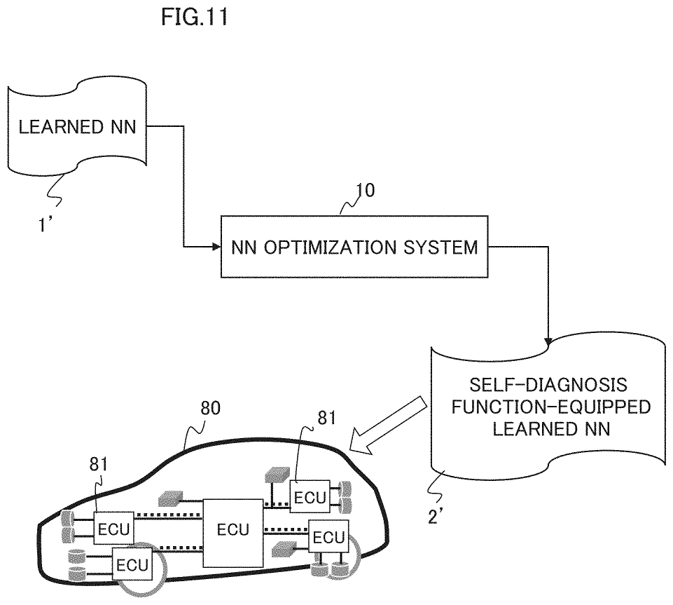

Next, FIG. 11 illustrates a configuration example of an electronic device 80 according to the second embodiment of the present invention. The electronic device 80 is an automobile in which a self-diagnosis function-equipped learned NN 2′ is implemented on a plurality of electronic control units (ECU) 81, for example. The ECU 81 corresponds to an AI processing unit of the present invention.

According to the electronic device 80, because AI processing using the self-diagnosis function-equipped learned NN 2′ is enabled in each of the ECUs 81, for example, improvement in safety performance of the automobile, a reduction in weight, improvement in energy efficiency, and the like can be achieved.

Note that a specific example of the electronic device 80 is not limited to the automobile, and may be a ship, an airplane, a robot, or the like.

<Configuration Example of Electronic Device 100 According to Third Embodiment of Present Invention>

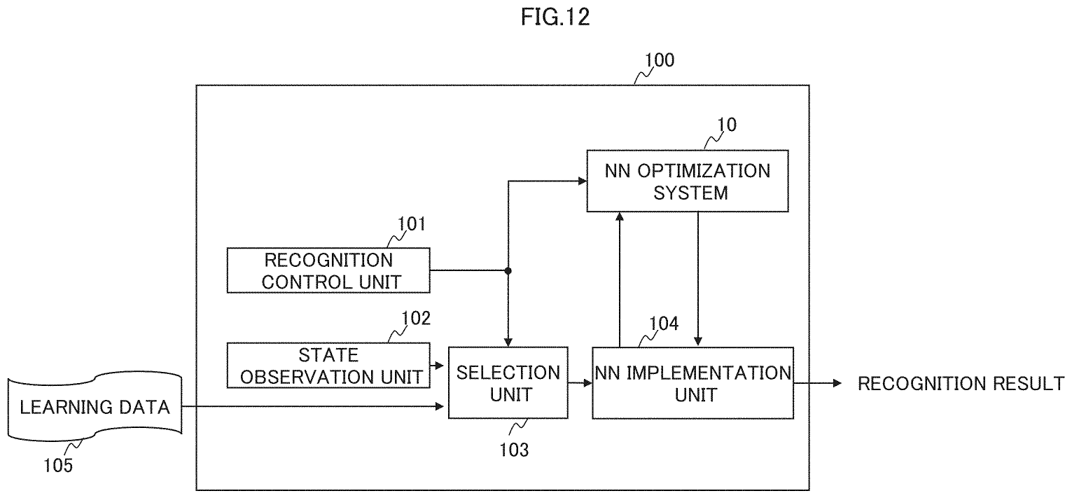

Next, FIG. 12 illustrates a configuration example of an electronic device 100 according to the third embodiment of the present invention. The electronic device 100 is, for example, an automobile, a ship, an airplane, a robot, or the like. The electronic device 100 includes the NN optimization system 10 illustrated in FIG. 1. Furthermore, the electronic device 100 includes a recognition control unit 101, a state observation unit 102, a selection unit 103, and an NN implementation unit 104. The recognition control unit 101, the state observation unit 102, the selection unit 103, and the NN implementation unit 104 are implemented by the same computer as the computer implementing the NN optimization system 10, or a different computer.

The NN optimization system 10 in the electronic device 100 can add a diagnosis circuit to the learned NN 1′ implemented on the NN implementation unit 104, and return the learned NN 1′ to the NN implementation unit 104 as the self-diagnosis function-equipped learned NN 2′. Furthermore, the NN optimization system 10 can optimize (deletion and re-addition of diagnosis circuit) the self-diagnosis function-equipped learned NN 2′ learned again by the NN implementation unit 104. In other words, the NN optimization system 10 can add again an autonomous and highly-efficient diagnosis circuit.

By controlling the selection unit 103 and outputting state information from the state observation unit 102 or learning data 105 to the NN implementation unit 104, the recognition control unit 101 causes the NN implementation unit 104 to execute AI processing such as recognition using the implemented self-diagnosis function-equipped learned NN 2′, or relearning of the self-diagnosis function-equipped learned NN 2′. In addition, the recognition control unit 101 controls the NN optimization system 10 to execute optimization processing on the relearned self-diagnosis function-equipped learned NN 2′ implemented on the NN implementation unit 104.

The state observation unit 102 outputs the outputs of various sensors such as a camera or a radar, for example, to the selection unit 103 as state information. The selection unit 103 outputs state information from the state observation unit 102 or the learning data 105 to the NN implementation unit 104 in accordance with the control from the recognition control unit 101.

Using state information from the state observation unit 102 that is input via the selection unit 103, as an input, the NN implementation unit 104 can perform AI processing such as recognition or determination by the implemented self-diagnosis function-equipped learned NN 2′. In addition, based on the learning data 105 input via the selection unit 103, the NN implementation unit 104 can relearn the implemented self-diagnosis function-equipped learned NN 2′.

<Configuration Example of Electronic Device 110 According to Fourth Embodiment of Present Invention>

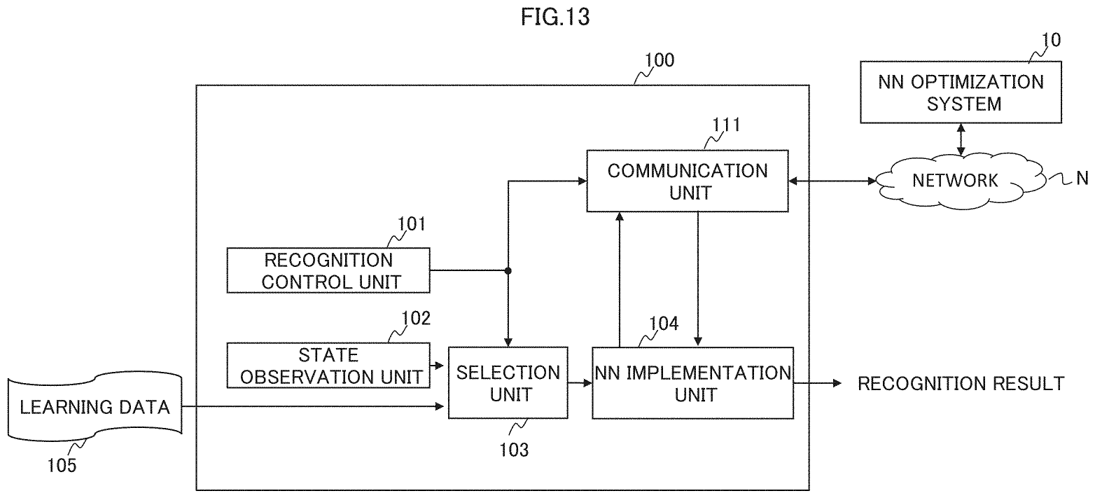

Next, FIG. 13 illustrates a configuration example of an electronic device 110 according to the fourth embodiment of the present invention. The electronic device 110 is, for example, an automobile, a ship, an airplane, a robot, or the like. The electronic device 110 is obtained by moving the NN optimization system 10 in the electronic device 100 (FIG. 12) to a server or the like on a cloud, and adding a communication unit 111. The communication unit 111 can connect to the NN optimization system 10 via a network N. The network N is a two-way communication network represented by the Internet, for example.

According to the electronic device 110, in addition to the effects and functions similar to those of the electronic device 100, the scale and processing steps on the electronic device 110 side can be reduced. Furthermore, according to the electronic device 110, in a case where abnormality is detected in an NN, the detection time, a position address, and the like can be transmitted to an external system (for example, a movement destination server of the NN optimization system 10). In the external system, the transmitted information is collected and analyzed, and a maintenance service such as determination of severity, a repair instruction, and repair schedule planning can be implemented.

The present invention is not limited to the above-described embodiments, and various modifications can be made. For example, the above-described embodiments have been described in detail for clearly explaining the present invention, and are not necessarily limited to embodiments including all the described configurations. In addition, a part of configurations of a certain embodiment can be replaced with a configuration of a different embodiment, or a configuration of a different embodiment can be added.

In addition, the above-described configurations, functions, processing units, processing means, and the like may be partially or entirely achieved by hardware by designing by integrated circuits, for example. In addition, the above-described configurations, functions, and the like may be achieved by software by a processor interpreting and executing programs for achieving the functions. Information such as programs, tables, and files for achieving the functions can be stored on a recording device such as a memory, a hard disk, or a solid state drive (SSD), or a recording medium such as an IC card, an SD card, or a DVD. In addition, control lines and information lines considered to be necessary for the sake of explanation are indicated, and not all of the control lines and information lines of a product are always indicated. In fact, it may be considered that almost all of the configurations are interconnected.

### REFERENCE SIGNS LIST

1 Learned NN definition data
1′ Learned NN
2 Self-diagnosis function-equipped learned NN definition data
2′ Self-diagnosis function-equipped learned NN
10 NN optimization system
11 Definition data analysis unit
12 Internode dependence degree analysis unit
13 Sensitive node extraction unit
14 Diagnosis circuit addition unit
15 Diagnosis circuit storage unit
21 Sensitive node data information
22 External device
31 Error injection processing unit
32 Comparison determination unit
33 Test pattern
34 Expected value pattern
41 Internode correlation analysis unit
42 Affecting node region storage unit
43 Reduction unit
44 Reduced test pattern storage unit
51 Input layer
52 Hidden layer
53 Output layer
61 Input data buffer
62 Memory
63 Calculator
70 Diagnosis circuit
71 Calculator
72 Comparator
80 Electronic device
100 Electronic device
101 Recognition control unit
102 State observation unit
103 Selection unit
104 NN implementation unit
105 Learning data
110 Electronic device
111 Communication unit
N Network

1. A neural network optimization system comprising:
a definition data analysis unit configured to analyze learned neural network definition data;
an internode dependence degree analysis unit configured to generate dependence degree information indicating an internode dependence degree in a learned neural network defined by the learned neural network definition data, based on an analysis result of the learned neural network definition data; and
a sensitive node extraction unit configured to extract a sensitive node in the learned neural network based on the dependence degree information.

2. The neural network optimization system according to claim 1, comprising
a diagnosis circuit addition unit configured to add a diagnosis circuit to the extracted sensitive node among all nodes in the learned neural network.

3. The neural network optimization system according to claim 2, wherein
the diagnosis circuit addition unit
adds the diagnosis circuit that performs same calculation as the sensitive node, and compares a calculation result thereof and an output of the sensitive node,
to the sensitive node.

4. The neural network optimization system according to claim 3, wherein,
in a case where the calculation result and the output of the sensitive node are different, the diagnosis circuit determines abnormality, and outputs abnormality-detected node identification information.

5. The neural network optimization system according to claim 1, wherein
the internode dependence degree analysis unit includes:
an error injection processing unit configured to write error data into at least one of data exchanged between nodes of the learned neural network, and a parameter in each node, based on an analysis result of the learned neural network definition data, and then input a test pattern to the learned neural network; and
a comparison determination unit configured to compare an output obtained by inputting the test pattern to the learned neural network into which the error data is written, and an expected value pattern corresponding to the test pattern, and generate the dependence degree information based on a comparison result.

6. The neural network optimization system according to claim 5, wherein
the internode dependence degree analysis unit includes:
an internode correlation analysis unit configured to identify a node region with a small bonding degree in the learned neural network based on an analysis result of the learned neural network definition data; and
a reduction unit configured to generate a reduced test pattern obtained by omitting data to be input to the node region with the small bonding degree, from the test pattern, and
the error injection processing unit writes the error data and then inputs the reduced test pattern to the learned neural network.

7. A neural network optimization method executed by a neural network optimization system, the neural network optimization method comprising:
a definition data analysis step of analyzing learned neural network definition data;
an internode dependence degree analysis step of generating dependence degree information indicating an internode dependence degree in a learned neural network defined by the learned neural network definition data, based on an analysis result of the learned neural network definition data; and
a sensitive node extraction step of extracting a sensitive node in the learned neural network based on the dependence degree information.

8. An electronic device comprising:
a definition data analysis unit configured to analyze learned neural network definition data;
an internode dependence degree analysis unit configured to generate dependence degree information indicating an internode dependence degree in a learned neural network defined by the learned neural network definition data, based on an analysis result of the learned neural network definition data;
a sensitive node extraction unit configured to extract a sensitive node in the learned neural network based on the dependence degree information; and
an AI processing unit on which a learned neural network to which a diagnosis circuit is added by a neural network optimization system including a diagnosis circuit addition unit configured to add the diagnosis circuit to the extracted sensitive node among all nodes in the learned neural network is implemented.

9. An electronic device comprising:
a neural network implementation unit configured to implement a learned neural network and perform Al processing; and
a neural network optimization system configured to optimize the learned neural network implemented by the neural network implementation unit, wherein
the neural network optimization system includes:
a definition data analysis unit configured to analyze learned neural network definition data;
an internode dependence degree analysis unit configured to generate dependence degree information indicating an internode dependence degree in a learned neural network defined by the learned neural network definition data, based on an analysis result of the learned neural network definition data;
a sensitive node extraction unit configured to extract a sensitive node in the learned neural network based on the dependence degree information; and
a diagnosis circuit addition unit configured to add a diagnosis circuit to the extracted sensitive node among all nodes in the learned neural network.

10. An electronic device comprising:
a neural network implementation unit configured to implement a learned neural network and perform Al processing; and
a communication unit configured to communicate, via a network, with a neural network optimization system configured to optimize the learned neural network implemented by the neural network implementation unit, wherein
the neural network optimization system includes:
a definition data analysis unit configured to analyze learned neural network definition data;
an internode dependence degree analysis unit configured to generate dependence degree information indicating an internode dependence degree in a learned neural network defined by the learned neural network definition data, based on an analysis result of the learned neural network definition data;
a sensitive node extraction unit configured to extract a sensitive node in the learned neural network based on the dependence degree information; and
a diagnosis circuit addition unit configured to add a diagnosis circuit to the extracted sensitive node among all nodes in the learned neural network.

11. The electronic device according to claim 9, wherein
the neural network implementation unit performs relearning of the learned neural network based on learning data, and
the neural network optimization system optimizes the learned neural network that has been relearned.

12. The electronic device according to claim 10, wherein,
in a case where abnormality is detected by the diagnosis circuit added to the learned neural network, the communication unit outputs abnormality-detected node identification information to an external system.
